(19) United States
(12) Patent Application Publication
(10) Pub. No.: US 2024/0043576 A1
(43) Pub. Date: Feb. 8, 2024

(54) Carbonate Compounds as Activity Limiting Agents in Ziegler-Natta Catalyst Compositions for Olefin Polymerization

(71) Applicant: Formosa Plastics Corporation, U.S.A., Livingston, NJ (US)

(72) Inventors: Lei Zhang, Port Lavaca, TX (US); Gapgoung Kong, Sugarland, TX (US); Guangxue Xu, Port Lavaca, TX (US); Cyrus C. Y. Lee, Victoria, TX (US); Chih-Jian Chen, Port Lavaca, TX (US)

(21) Appl. No.: 17/882,774

(22) Filed: Aug. 8, 2022

(51) Int. Cl. C08F 4/642; C08F 10/06

(52) U.S. Cl. CPC C08F 4/6421; C08F 10/06; C08F 2410/01

(57) ABSTRACT

Disclosed is a Ziegler-Natta catalyst composition comprising one or more Ziegler-Natta procatalyst compositions which comprise magnesium, titanium, a halogen, one or more internal electron donors; one or more aluminum containing cocatalysts; optionally one or more stereo-selectivity control agents (SCA); and one or more activity limiting agents (ALA) comprising one or more alkyl-, cycloalkyl- or aryl carbonates and derivatives. Such a Ziegler-Natta catalyst composition exhibits self-limiting catalyst activity in olefin polymerization, particularly propylene polymerization.

### BACKGROUND

### 1. Field of the Invention

This invention relates to a Ziegler-Natta catalyst composition comprising one or more Ziegler-Natta procatalyst compositions which comprise magnesium, titanium, a halogen, one or more internal electron donors; one or more aluminum containing cocatalysts; optionally one or more external stereo-selectivity control agents (SCA); and one or more activity limiting agents (ALA) which comprise one or more alkyl-, cycloalkyl- or aryl carbonates and derivatives. The invention further relates to methods for making said novel polymerization catalyst composition, and to polymerization processes for producing polyolefins, particularly polypropylene, using the novel catalyst composition.

### 2. Description of the Related Art

Ziegler-Natta catalyst compositions for olefin polymerization are well known in the art. Commonly, these catalyst systems are composed of a solid Ziegler-Natta procatalyst component and a cocatalyst component, usually an organoaluminum compound. To increase the activity and stereo-specificity of the catalyst system for the polymerization of α-olefins, electron donating compounds have been incorporated into the Ziegler-Natta procatalyst component during catalyst preparation, which is used as an internal electron donor, and/or it can be charged into polymerization reactor during the polymerization process, which is used as an external stereo-selectivity control agent (SCA) in conjunction with the solid Ziegler-Natta procatalyst component and the cocatalyst component.

Common internal electron donor compounds, which are incorporated in the solid Ziegler-Natta procatalyst component during preparation of such component, are well known in the art and include organic acid esters, ethers, ketones, amines, alcohols, heterocyclic organic compounds, phenols, phosphines, and silanes, etc. It is well known in the art that polymerization activity, as well as stereo-regularity, molecular weight, and molecular weight distribution of the resulting polymer, depend on the molecular structure of the internal electron donor employed. Therefore, in order to improve the polymerization process and the properties of the resulting polymer, there has been an effort and desire to develop various internal electron donors. Examples of such internal electron donor compounds and their use as a component of the catalyst system are described in U.S. Pat. Nos. 4,107,414; 4,186,107; 4,226,963; 4,347,160; 4,382,019; 4,435,550; 4,465,782; 4,522,930; 4,530,912; 4,532,313; 4,560,671; 4,657,882; 5,208,302; 5,902,765; 6,048,818; 6,121,483; 6,281,301; 6,294,497; 6,313,238; 6,395,670,6,436,864, 6,605,562; 6,716,939; 6,770,586; 6,818,583; 6,825,309; 7,022,640; 7,049,377; 7,202,314; 7,208,435; 7,223,712; 7,351,778; 7,371,802; 7,491,781; 7,544,748; 7,674,741; 7,674,943; 7,888,437; 7,888,438; 7,935,766; 7,964,678; 8,003,558; 8,003,559; 8,088,872; 8,211,819; 8,222,357; 8,227,370; 8,236,908; 8,247,341; 8,263,520; 8,263,692; 8,288,304; 8,288,585; 8,288,606; 8,318,626; 8,383,540; 8,536,290 8,569,195; 8,575,283; 8,604,146; 8,633,126; 8,692,927; 8,664,142; 8,680,222; 8,716,514 and 8,742,040, which are incorporated by reference in their entireties herein.

Acceptable external stereo-selectivity control agents (SCA) include organic compounds containing O, Si, N, S, and/or P. Such compounds include organic acids, organic acid esters, organic acid anhydrides, ethers, ketones, alcohols, aldehydes, silanes, amides, amines, amine oxides, thiols, and various phosphorus acid esters and amides, etc. Preferred external SCA's are organosilicon compounds containing Si—O—C and/or Si—N—C bonds, having silicon as the central atom. Such compounds are described in U.S. Pat. Nos. 4,472,524; 4,473,660; 4,560,671; 4,581,342; 4,657,882; 5,106,807; 5,407,883; 5,684,173; 6,228,961; 6,362,124; 6,552,136; 6,689,849; 7,009,015; 7,244,794; 7,276,463; 7,619,049; 7,790,819; 8,247,504; 8,648,001; and 8,614,162, which are incorporated by reference in their entireties herein.

With regard to the temperature dependence of catalyst activity, activity limiting agents (ALA) have been developed recently. In combination with a Ziegler-Natta procatalyst composition and an external SCA, the use of certain carboxylic acid esters, diethers, and derivatives results in an inherently self-limiting catalyst composition with respect to temperature. Such catalyst compositions are much less active at elevated polymerization temperatures, especially temperatures above 100° C., compared to the catalyst activity under normal polymerization conditions with reaction temperature usually below 80° C. The advantages of using such catalyst compositions include less reactor fouling or sheeting and improved polymerization process control. Examples of such ester and diether compounds and their use as an ALA are described in U.S. Pat. Nos. 7,491,670; 7,678,868; 7,781,363; 8,536,290; 9,796,796; and which are incorporated by reference in their entireties herein.

Despite the advances occasioned by the foregoing disclosures, there are needs and desire for developing catalyst compositions which not only have reduced polymerization activity at elevated reaction temperatures, but also produce polyolefins with well-controlled physical properties, especially when the reaction temperature is above the normal range.

### SUMMARY OF THE INVENTION

The present invention is a Ziegler-Natta catalyst composition comprising one or more Ziegler-Natta procatalyst compositions which comprise magnesium, titanium, a halogen, one or more internal electron donors; one or more aluminum containing cocatalysts; optionally one or more stereo-selectivity control agents (SCA); and one or more activity limiting agents (ALA), which comprise one or more alkyl-, cycloalkyl- or aryl carbonates and derivatives. In one embodiment of the present invention, the Ziegler-Natta catalyst composition exhibits self-limiting catalyst activity in olefin polymerization, particularly propylene polymerization, to fulfill the aforementioned requirements.

The present invention relates to a catalyst system for the polymerization or co-polymerization of α-olefins comprising a solid Ziegler-Natta procatalyst component, a co-catalyst component, optionally an external SCA component, and a carbonate compound as the ALA component. Suitable ALA carbonate compounds in catalyst compositions of the present invention are represented by Formula I:

R¹OC(═O)OR² [Formula I]

wherein R¹ and R², which may be identical or different, are independently selected from hydrogen, an aliphatic hydrocarbon group having 1 to 20 carbon atoms, an alicyclic hydrocarbon group having 3-20 carbon atoms, an aromatic hydrocarbon group having 4-20 carbon atoms, or a heteroatom containing a hydrocarbon group of 1 to 20 carbon atoms, wherein R¹ and R² may be linked to form one or more saturated or unsaturated monocyclic or polycyclic rings.

### DESCRIPTION OF PREFERRED EMBODIMENTS

The present invention provides a catalyst composition for the polymerization and copolymerization of olefins, particularly propylene or mixtures of propylene and comonomers, said catalyst composition comprising one or more Ziegler-Natta procatalyst compositions which comprise magnesium, titanium, a halogen, one or more internal electron donors; one or more aluminum containing cocatalysts; optionally one or more external stereo-selectivity control agents (SCA); and one or more activity limiting agents (ALA) which comprise one or more alkyl-, cycloalkyl- or aryl carbonates and derivatives, said ALA compounds and amounts being charged to the polymerization reactor such that the polymerization activity of the catalyst composition at a temperature above 85° C., preferably above 100° C., is less than the polymerization activity of the catalyst composition in the absence of ALA at said temperature.

According to certain aspects of the present invention, suitable carbonate compounds in catalyst compositions of the present invention are represented by Formula I:

R¹OC(═O)OR² [Formula I]

wherein R¹ and R², which may be identical or different, are independently selected from hydrogen, an aliphatic hydrocarbon group having 1 to 20 carbon atoms, an alicyclic hydrocarbon group having 3-20 carbon atoms, an aromatic hydrocarbon group having 4-20 carbon atoms, or a hetero atom containing a hydrocarbon group of 1 to 20 carbon atoms, wherein R¹ and R² may be linked to form one or more saturated or unsaturated monocyclic or polycyclic rings.

Preferred examples of suitable carbonate compounds of Formula I include, but are not limited to: dimethyl carbonate, ethyl methyl carbonate, diethyl carbonate, dipropyl carbonate, di-n-butyl carbonate, propylene carbonate, 2-ethoxyethyl ethyl carbonate, didodecyl carbonate, diphenyl carbonate, t-butyl phenyl carbonate, bis(4-chlorophenyl) carbonate, 3,4-dichlorobenzyl hexyl carbonate, ethylene glycol bis-(methyl carbonate), diethyl 2,5-dioxahexanedioate.

Typical, and acceptable, Ziegler-Natta catalyst compositions that may be used in accordance with the present invention comprise (a) a solid Ziegler-Natta procatalyst component, (b) a co-catalyst component, optionally (c) one or more stereo-selectivity control agents (SCA), and (d) one or more carbonate compounds of Formula I employed as activity limiting agents (ALA).

Preferred solid Ziegler-Natta procatalyst component (a) include solid catalyst components comprising a titanium compound having at least a Ti-halogen bond and an internal electron donor supported on an anhydrous magnesium-dihalide support. Such preferred solid Ziegler-Natta procatalyst component (a) include solid catalyst components comprising a titanium tetrahalide. A preferred titanium tetrahalide is TiCl₄. Alkoxy halides may also be used solid Ziegler-Natta procatalyst component (a).

The internal electron donors for the preparation of solid Ziegler-Natta procatalyst component (a) can be chosen from commonly used internal donors such as aliphatic/aromatic esters, phthalic esters, aliphatic/aromatic 1,3-diethers, malonic esters, succinic esters, carbonate compounds. In some embodiments, internal donors can be chosen from di-isobutyl phthalate, di-n-butyl phthalate, di-iso-octyl phthalate, 1,3-dipentyl phthalate, ethylbenzoate, ethyl benzoate, n-butyl benzoate, methyl-p-toluate, and methyl-p-methoxybenzoate and diisobutylphthalate, diethyldiisobutylmalonate, diethylisopropylmalonate, diethylphenylmalonate, dimethyldiisobutylmalonate, dimethylphenylmalonate, 9,9-bis(methoxymethyl)fluorene; 9,9-bis(methoxymethyl)-2,3,6,7-tetramethylfluorene; 9,9-bis(methoxymethyl)-2,3,4,5,6,7-hexafluorofluorene; 9,9-bis(methoxymethyl)-2,3-benzofluorene; 9,9-bis(methoxymethyl)-2,3,6,7-dibenzofluorene; 9,9-bis(methoxymethyl)-2,7-diisopropylfluorene; 9,9-bis(methoxymethyl)-1,8-dichlorofluorene; 9,9-bis(methoxymethyl)-2,7-dicyclopentylfluorene; 9,9-bis(methoxymethyl)-1,8-difluorofluorene; 9,9-bis(methoxymethyl)-1,2,3,4-tetrahydrofluorene; 9,9-bis(methoxymethyl)-1,2,3,4,5,6,7,8-octahydrofluorene; 9,9-bis(methoxymethyl)-4-tert-butylfluorene, diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmethyl)succinate, diethyl 2,3-diisobutylsuccinate, diethyl 2,3-dineopentylsuccinate, diethyl 2,3-dicyclopentylsuccinate, diethyl 2,3-dicyclohexylsuccinate, Other common internal electron donors, including alkyl or alkyl-aryl ethers, polyethers, ketones, mono- or polyamines, heterocyclic organic compounds, aldehydes, and P-containing compounds, such as phosphines and phosphoramides, may also be used.

Acceptable anhydrous magnesium dihalides forming the support of the solid Ziegler-Natta procatalyst component (a) are magnesium dihalides in active form that are well known in the art. Such magnesium dihalides may be pre-activated, may be activated in situ during the titanation, may be formed in-situ from a magnesium compound, which is capable of forming magnesium dihalide when treated with a suitable halogen-containing transition metal compound, and then activated. Preferred magnesium dihalides are magnesium dichloride and magnesium dibromide. The water content of the dihalides is generally less than 1% by weight.

The solid Ziegler-Natta procatalyst component (a) may be made by various methods. One such method consists of co-grinding the magnesium dihalide and the internal electron donor compound until the product shows a surface area higher than 20 m²/g and thereafter reacting the ground product with the Ti compound. Other methods of preparing solid Ziegler-Natta procatalyst component (a) are disclosed in U.S. Pat. Nos. 4,220,554; 4,294,721; 4,315,835; 4,330,649; 4,439,540; 4,816,433; and 4,978,648. These methods are incorporated herein by reference.

In a typical solid Ziegler-Natta procatalyst component (a), the molar ratio between the magnesium dihalide and the halogenated titanium compound is between 1 and 500, the molar ratio between said halogenated titanium compound and the internal electron donor is between 0.1 and 50.

Preferred co-catalyst component (b) includes aluminum alkyl compounds. Acceptable aluminum alkyl compounds include aluminum trialkyls, such as aluminum triethyl, aluminum triisobutyl, and aluminum triisopropyl. Other acceptable aluminum alkyl compounds include aluminum-dialkyl hydrides, such as aluminum-diethyl hydrides. Other acceptable co-catalyst component (b) include compounds containing two or more aluminum atoms linked to each other through hetero-atoms, such as:
(C₂H₅)₂Al—O—Al(C₂H₅)₂
(C₂H₅)₂Al—N(C₆H₅)—Al(C₂H₅)₂; and
(C₂H₅)₂Al—O—SO₂—O—Al(C₂H₅)₂.

Acceptable external stereo-selectivity control agents (SCA) (c) are organic compounds containing O, Si, N, S, and/or P. Such compounds include organic acids, organic acid esters, organic acid anhydrides, ethers, ketones, alcohols, aldehydes, silanes, amides, amines, amine oxides, thiols, various phosphorus acid esters and amides, etc. Preferred SCA component (c) is organosilicon compounds containing Si—O—C and/or Si—N—C bonds. Special examples of such organosilicon compounds are trimethylmethoxysilane, diphenyldimethoxysilane, cyclohexylmethyldimethoxysilane, diisopropyldimethoxysilane, dicyclopentyldimethoxysilane, isobutyltriethoxysilane, vinyltrimethoxysilane, dicyclohexyldimethoxysilane, 3-tert-Butyl-2-isobutyl-2methoxy-[1,3,2]oxazasilolidine, 3-tert-Butyl-2-cyclopentyl-2-methoxy-[1,3,2]oxazasilolidine, 2-Bicyclo[2.2.1]hept-5-en-2-yl-3-tert-butyl-2-methoxy-[1,3,2]oxazasilolidine, 3-tert-Butyl-2,2-diethoxy-[1,3,2]oxazasilolidine, 4,9-Di-tert-butyl-1,6-dioxa-4,9-diaza-5-sila-spiro[4.4]nonane, bis(perhydroisoquinolino)dimethoxysilane, etc. Mixtures of organic electron donors may also be used.

The olefin polymerization processes that may be used in accordance with the present invention are not generally limited. For example, the catalyst components (a), (b), (c), and (d), when employed, may be added to the polymerization reactor simultaneously or sequentially. It is preferred to mix components (b), (c), and (d) first and then contact the resultant mixture with component (a) prior to the polymerization.

The olefin monomer may be added prior to, with, or after the addition of the Ziegler-Natta catalyst composition to the polymerization reactor. It is preferred to add the olefin monomer after the addition of the Ziegler-Natta catalyst composition.

The molecular weight of the polymers may be controlled in a known manner, preferably by using hydrogen. With the catalysts produced according to the present invention, molecular weight may be suitably controlled with hydrogen when the polymerization is carried out at relatively low temperatures, e.g., from about 30° C. to about 95° C. This control of molecular weight may be evidenced by a measurable positive change of the melt flow rate (MFR).

The polymerization reactions may be carried out in slurry, liquid or gas phase processes, or in a combination of liquid and gas phase processes using separate reactors, all of which may be done either by batch or continuously. The polyolefin may be directly obtained from gas phase process, or obtained by isolation and recovery of solvent from the slurry process, according to conventionally known methods.

There are no particular restrictions on the polymerization conditions for production of polyolefins by the method of this invention, such as the polymerization temperature, polymerization time, polymerization pressure, monomer concentration, etc. The polymerization temperature is generally from 40-90° C. and the polymerization pressure is generally 1 atmosphere or higher.

The Ziegler-Natta catalyst composition of the present invention may be pre-contacted with small quantities of olefin monomer, well known in the art as pre-polymerization, in a hydrocarbon solvent at a temperature of 60° C. or lower for a time sufficient to produce a quantity of polymer from 0.5 to 5 times the weight of the catalyst. If such a pre-polymerization is done in liquid or gaseous monomer, the quantity of resultant polymer is generally up to 1000 times the catalyst weight.

The Ziegler-Natta catalyst composition of the present invention is useful in the polymerization of olefins, including but not limited to homo-polymerization and copolymerization of alpha olefins. Suitable α-olefins that may be used in a polymerization process in accordance with the present invention include olefins of the general formula CH₂═CHR, where R is H or C₁₋₁₀ straight or branched alkyl, such as ethylene, propylene, butene-1, pentene-1, 4-methylpentene-1 and octene-1. While the Ziegler-Natta catalyst composition of the present invention may be employed in processes in which ethylene is polymerized, it is more desirable to employ the Ziegler-Natta catalyst composition of the present invention in processes in which polypropylene or higher olefins are polymerized. Processes involving the homo-polymerization or copolymerization of propylene are preferred.

### EXAMPLES

In order to provide a better understanding of the foregoing, the following non-limiting examples are offered. Although the examples may be directed to specific embodiments, they are not to be viewed as limiting the invention in any specific respect. The activity values (AC) are based upon grams of polymer produced per gram of solid catalyst component used.

The following analytical methods are used to characterize the polymer.

Heptane Insolubles (HI %): The weight percent (wt %) of residuals of polypropylene sample after extracted with boiling heptane for 8 hours.

Melt Flow Rate (MFR): ASTM D-1238, determined at 230° C. under the load of 2.16 kg.

Magnesium ethoxide (98%), anhydrous toluene (99.8%), TiCl₄ (99.9%), anhydrous n-heptane (99%), diisobutyl phthalate (99%), cyclohexyl(dimethoxy)methylsilane (C-donor, ≥99%) and triethylaluminum (93%) were all purchased from Sigma-Aldrich Co. of Milwaukee, WI, USA. Diisopropyldimethoxysilane (P-donor) was purchased from Gelest, Inc. of Morrisville, PA, USA. 2-ethoxyethyl ethyl carbonate and 2-isopropyl-2-(1-methylbutyl)-1,3-dimethoxypropane were provided by Toho Titanium Co., LTD. Diethyl carbonate (98%) and di-n-butyl carbonate (98%) were purchase from TCI America.

Unless otherwise indicated, all reactions were conducted under an inert atmosphere.

### Example 1

### (A) The Preparation of a Solid Catalyst Component (A-1)

A three neck 250 ml flask equipped with fritted filter disk and mechanical stirrer, which is thoroughly purged with nitrogen, was charged with 80 mmol of magnesium ethoxide and 80 ml of anhydrous toluene to form a suspension. To the suspension was added 20 ml of TiCl₄, and the reaction mixture was then heated up to a temperature of 90° C. 10 mmol of diisobutyl phthalate (DIBP) as internal electron donor was added thereto, followed by heating up to 110° C. with agitation at that temperature for 2 hours. After the completion of the reaction, the resulting solid was filtered and washed twice with 100 ml of anhydrous toluene at 90° C., and 80 ml of fresh anhydrous toluene and 20 ml of TiCl₄ were added thereto for reacting with agitation at 110° C. for two additional hours. After the completion of the reaction, the solid was filtered and washed 7 times with 100 ml of anhydrous n-heptane at 90° C. and was dried under a reduced pressure to obtain a solid composition (A-1).

### (B) Propylene Slurry Polymerization

Propylene polymerization was conducted in a bench scale 2-liter reactor per the following procedure.

The reactor was first preheated to at least 100° C. with a nitrogen purge to remove residual moisture and oxygen. The reactor was thereafter cooled to 50° C. Under nitrogen, 1 liter dry heptane was introduced into the reactor. When reactor temperature was about 50° C., 4.3 ml of triethylaluminum (0.6 M in hexanes), 0.4 ml of diisopropyl(dimethoxy)silane (P-donor) (0.5 M in heptane), 1.0 ml of diethyl carbonate solution (0.3 M in heptane) and then 30 mg of the solid catalyst component (A-1) prepared above were added to the reactor. The temperature of the reactor was heated to 50° C. and 30 psi of hydrogen in a 150 ml vessel was flushed into the reactor with propylene.

The reactor temperature was then raised to 70° C., or above. The total reactor pressure was raised to and controlled at 90 psig by continually introducing propylene into the reactor and the polymerization was allowed to proceed for 1 hour. After polymerization, the reactor was vented to reduce the pressure to 0 psig and the reactor temperature was cooled to 50° C. The reactor was then opened. 500 ml methanol was added to the reactor and the resulting mixture was stirred for 5 minutes then filtered to obtain the polymer product. The obtained polymer was vacuum dried at 80° C. for 6 hours.

The polymer was evaluated for melt flow rate (MFR), heptane insoluble (HI %). The activity of catalyst (AC) was also measured. The results are shown in TABLE 1.

### Example 2

### (B) Propylene Slurry Polymerization

Propylene polymerization using catalyst component (A-1) was carried out in the same manner as described in Example 1, except that 1.0 ml of di-n-butyl carbonate solution (0.3 M in heptane) was used instead of 1.0 ml of diethyl carbonate solution (0.3 M in heptane). The results are shown in TABLE 1.

### Example 3

### (B) Propylene Slurry Polymerization

Propylene polymerization using catalyst component (A-1) was carried out in the same manner as described in Example 1, except that 0.67 ml of 2-ethoxyethyl ethyl carbonate (0.3 M in heptane) was used instead of 1.0 ml of diethyl carbonate solution (0.3 M in heptane). The results are shown in TABLE 1.

### Example 4

### (A) The Preparation of a Solid Catalyst Component (A-2)

Preparation of solid catalyst component (A-2) was carried out in the same way as Example 1, except that instead of 10 mmol of diisobutyl phthalate (DIBP) as internal electron donor, 7.5 mmol of 2-isopropyl-2-(1-methylbutyl)-1,3-dimethoxypropane and 7.5 mmol of diethyl 2,3-diisopropyl succinate were added to make catalyst component (A-2).

### (B) Propylene Slurry Polymerization

Propylene polymerization using catalyst component (A-2) was carried out in the same manner as described in Example 1, except that 0.67 ml of diethyl carbonate solution (0.3 M in heptane) was charged and 10 psi of hydrogen in a 150 ml vessel was flushed into the reactor with propylene. The results are shown in TABLE 1.

### Comparative Example 1

### (B) Propylene Slurry Polymerization

Propylene polymerization using catalyst component (A-1) was carried out in the same manner as described in Example 1, except that diethyl carbonate was not added. The results are shown in TABLE 1.

### Comparative Example 2

### (B) Propylene Bulk Polymerization

Propylene polymerization using catalyst component (A-2) was carried out in the same manner as described in Example 4, except that diethyl carbonate was not added. The results are shown in TABLE 1.

TABLE 1

| | Catalyst | | | | AC | AC/ | MFR | |
|---|---|---|---|---|---|---|---|---|
| Example | com- | SCA* | ALA** | Temp | (g/ | AC₇₀ | (g/10 | HI |
| number | ponent | (mmol) | (mmol) | (° C.) | g/hr) | (%)*** | min) | (%) |
| Example | A-1 | P (0.2) | DEC | 70 | 6337 | 91 | 12 | 99.0 |
| 1 | | | (0.3) | 90 | 4067 | 58 | 33 | 97.9 |
| | | | | 100 | 3050 | 43 | 87 | 95.9 |
| Example | A-1 | P (0.2) | DBC | 70 | 6514 | 93 | 11 | 98.9 |
| 2 | | | (0.3) | 90 | 4347 | 62 | 52 | 97.1 |
| | | | | 100 | 2760 | 39 | 94 | 96.1 |
| Example | A-1 | P (0.2) | EEC | 70 | 5077 | 73 | 11 | 98.8 |
| 3 | | | (0.2) | 90 | 3430 | 49 | 26 | 97.8 |
| | | | | 100 | 2610 | 37 | 91 | 96.0 |
| Com- | A-1 | P (0.2) | none | 70 | 6977 | 100 | 11 | 98.7 |
| parative | | | | 90 | 5270 | 76 | 69 | 96.8 |
| example | | | | 100 | 4067 | 58 | 102 | 95.9 |
| 1 | | | | | | | | |
| Example | A-2 | P (0.2) | DEC | 70 | 4277 | 81 | 4 | 98.7 |
| 4 | | | (0.2) | 90 | 3077 | 58 | 22 | 96.4 |
| | | | | 100 | 1437 | 27 | 50 | 93.7 |
| Com- | A-2 | P (0.2) | none | 70 | 5304 | 100 | 4 | 98.6 |
| parative | | | | 90 | 3410 | 64 | 23 | 96.6 |
| example | | | | 100 | 2604 | 49 | 57 | 92.6 |
| 2 | | | | | | | | |

*P = diisopropyldimethoxysilane
**DEC = diethyl carbonate;
DBC = di-n-butyl carbonate;
EEC = 2-ethoxyethyl ethyl carbonate
***AC₇₀ = activity of the corresponding comparative example at 70° C.

As is clear from the above results shown in Table 1, by using carbonate compounds as activity limiting agents (ALA), in accordance with the teachings of the present invention, has achieved reduced polymerization activity at elevated polymerization temperatures. This is compared and contrasted to the use of silane (SCA) compounds alone, as well as using the same SCA/ALA mixture at a lower polymerization temperature. For example, in Table 1, polymerization activity at 100° C. in Examples 1, 2, and 3 is about 40% of the activity of Comparative Example 1 at 70° C., while in the absence of carbonate compounds as ALA, polymerization activity at 100° C. is about 60% of activity at 70° C. Also, polymerization activity at 100° C. in Example 4 is 27% of the activity of Comparative Example 2 at 70° C., while in the absence of carbonate compounds as ALA, polymerization activity at 95° C. is about 50% of activity at 70° C. These illustrated compositions possess self-limiting polymerization properties. Furthermore, a person having ordinary skill in the art will understand from the data that the presence of carbonate compounds as ALA in the catalyst composition improves the polymer isotacticity (HI %), compared to the corresponding comparative examples.

In yet another embodiment of the present invention, a catalyst composition for the polymerization of olefins, preferably propylene, is provided, comprising: one or more Ziegler-Natta procatalyst components comprising magnesium, titanium, a halogen, and one or more internal electron donors; one or more aluminum containing cocatalysts; and one or more activity limiting agents (ALA) comprising one or more alkyl-, cycloalkyl- or aryl carbonates and derivatives thereof.

In a preferred aspect of this embodiment, at least one of the one or more ALA are represented by Formula I:

R¹OC(═O)OR² [Formula I]

wherein R¹ and R² are independently selected from hydrogen, an aliphatic hydrocarbon group having 1 to 20 carbon atoms, an alicyclic hydrocarbon group having 3-20 carbon atoms, an aromatic hydrocarbon group having 4-20 carbon atoms, or a hetero atom containing a hydrocarbon group of 1 to 20 carbon atoms; and wherein R¹ and R² may be linked to form one or more saturated or unsaturated monocyclic or polycyclic rings.

In a preferred aspect of this embodiment, the catalyst composition the one or more ALA is diethyl carbonate, di-n-butyl carbonate, or 2-ethoxyethyl ethyl carbonate, although it is envisioned that the one or more ALA may be selected from dimethyl carbonate, ethyl methyl carbonate, diethyl carbonate, dipropyl carbonate, di-n-butyl carbonate, propylene carbonate, 2-ethoxyethyl ethyl carbonate, didodecyl carbonate, diphenyl carbonate, t-butyl phenyl carbonate, bis(4-chlorophenyl) carbonate, 3,4-dichlorobenzyl hexyl carbonate, ethylene glycol bis-(methyl carbonate), or diethyl 2,5-dioxahexanedioate.

In a preferred aspect of this embodiment, the catalyst composition may further include one or more external stereo-selectivity control agents (SCA), which is preferably a compound comprising Si—O—C or Si—N—C bonds, wherein silicon is the central atom in the compound.

In accordance with these teachings, the resulting polymerization activity at 100° C. is less than 43% the polymerization activity at 70° C. of a catalyst composition without one or more ALA, or less than 39% the polymerization activity at 70° C. of a catalyst composition without one or more ALA, or less than 37% the polymerization activity at 70° C. of a catalyst composition without one or more ALA, or less than 27% the polymerization activity at 70° C. of a catalyst composition without one or more ALA.

In yet another embodiment of the present invention, a method polymerizing olefins, preferably propylene, is disclosed utilizing the catalyst composition described hereinabove. In accordance with certain teachings of the present disclosure, the resulting polymerization activity at 100° C. is less than 43% the polymerization activity at 70° C. of a catalyst composition without one or more ALA, or less than 39% the polymerization activity at 70° C. of a catalyst composition without one or more ALA, or less than 37% the polymerization activity at 70° C. of a catalyst composition without one or more ALA, or less than 27% the polymerization activity at 70° C. of a catalyst composition without one or more ALA.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

1. A catalyst composition for the polymerization of olefins, comprising:
one or more Ziegler-Natta procatalyst components comprising magnesium, titanium, a halogen, and one or more internal electron donors;
one or more aluminum containing cocatalysts; and
one or more activity limiting agents (ALA) comprising one or more alkyl-, cycloalkyl- or aryl carbonates and derivatives thereof.

2. The catalyst composition of claim 1, wherein at least one of the one or more ALA are represented by Formula I:
R1OC(═O)OR2 [Formula I]
wherein R¹ and R² are independently selected from hydrogen, an aliphatic hydrocarbon group having 1 to 20 carbon atoms, an alicyclic hydrocarbon group having 3-20 carbon atoms, an aromatic hydrocarbon group having 4-20 carbon atoms, or a hetero atom containing a hydrocarbon group of 1 to 20 carbon atoms; and
wherein R¹ and R² may be linked to form one or more saturated or unsaturated monocyclic or polycyclic rings.

3. The catalyst composition of claim 1, wherein the one or more ALA are selected from: dimethyl carbonate, ethyl methyl carbonate, diethyl carbonate, dipropyl carbonate, di-n-butyl carbonate, propylene carbonate, 2-ethoxyethyl ethyl carbonate, didodecyl carbonate, diphenyl carbonate, t-butyl phenyl carbonate, bis(4-chlorophenyl) carbonate, 3,4-dichlorobenzyl hexyl carbonate, ethylene glycol bis-(methyl carbonate), or diethyl 2,5-dioxahexanedioate.

4. The catalyst composition of claim 1, wherein the one or more ALA comprises diethyl carbonate.

5. The catalyst composition of claim 1, wherein the one or more ALA comprises di-n-butyl carbonate.

6. The catalyst composition of claim 1, wherein the one or more ALA comprises 2-ethoxyethyl ethyl carbonate.

7. The catalyst composition of claim 1, wherein the olefins comprise propylene.

8. The catalyst composition of claim 1, further comprising one or more external stereo-selectivity control agents (SCA).

9. The catalyst composition of claim 8, wherein at least one of the SCAs is a compound comprising Si—O—C or Si—N—C bonds, wherein silicon is the central atom in the compound.

10. The catalyst composition of claim 1, wherein the resulting polymerization activity at 100° C. is less than 43% the polymerization activity at 70° C. of a catalyst composition without one or more ALA.

11. The catalyst composition of claim 1, wherein the resulting polymerization activity at 100° C. is less than 39% the polymerization activity at 70° C. of a catalyst composition without one or more ALA.

12. The catalyst composition of claim 1, wherein the resulting polymerization activity at 100° C. is less than 37% the polymerization activity at 70° C. of a catalyst composition without one or more ALA.

13. The catalyst composition of claim 1, wherein the resulting polymerization activity at 100° C. is less than 27% the polymerization activity at 70° C. of a catalyst composition without one or more ALA.

14. A method for polymerizing olefins, comprising:
providing a catalyst composition comprising: one or more Ziegler-Natta procatalyst components comprising magnesium, titanium, a halogen, and one or more internal electron donors; one or more aluminum containing cocatalysts; and one or more activity limiting agents (ALA) comprising one or more alkyl-, cycloalkyl- or aryl carbonates and derivatives thereof;
reacting the olefins with the catalyst composition to form polyolefins.

15. The method of claim 14, wherein at least one of the one or more ALA are represented by Formula I:
R1OC(═O)OR2 [Formula I]
wherein R¹ and R2 are independently selected from hydrogen, an aliphatic hydrocarbon group having 1 to 20 carbon atoms, an alicyclic hydrocarbon group having 3-20 carbon atoms, an aromatic hydrocarbon group having 4-20 carbon atoms, or a hetero atom containing a hydrocarbon group of 1 to 20 carbon atoms; and wherein R¹ and R2 may be linked to form one or more saturated or unsaturated monocyclic or polycyclic rings.

16. The method of claim 14, wherein the one or more ALA are selected from: dimethyl carbonate, ethyl methyl carbonate, diethyl carbonate, dipropyl carbonate, di-n-butyl carbonate, propylene carbonate, 2-ethoxyethyl ethyl carbonate, didodecyl carbonate, diphenyl carbonate, t-butyl phenyl carbonate, bis(4-chlorophenyl) carbonate, 3,4-dichlorobenzyl hexyl carbonate, ethylene glycol bis-(methyl carbonate), or diethyl 2,5-dioxahexanedioate.

17. The method of claim 14, wherein the one or more ALA comprises diethyl carbonate.

18. The method of claim 14, wherein the one or more ALA comprises di-n-butyl carbonate.

19. The method of claim 14, wherein the one or more ALA comprises 2-ethoxyethyl ethyl carbonate.

20. The method of claim 14, wherein the olefins comprise propylene.

21. The method of claim 14, further comprising one or more external stereo-selectivity control agents (SCA).

22. The method of claim 21, wherein at least one of the SCAs is a compound comprising Si—O—C or Si—N—C bonds, wherein silicon is the central atom in the compound.

23. The method of claim 14, wherein the resulting polymerization activity at 100° C. is less than 43% the polymerization activity at 70° C. of a catalyst composition without one or more ALA.

24. The method of claim 14, wherein the resulting polymerization activity at 100° C. is less than 39% the polymerization activity at 70° C. of a catalyst composition without one or more ALA.

25. The method of claim 14, wherein the resulting polymerization activity at 100° C. is less than 37% the polymerization activity at 70° C. of a catalyst composition without one or more ALA.

26. The method of claim 14, wherein the resulting polymerization activity at 100° C. is less than 27% the polymerization activity at 70° C. of a catalyst composition without one or more ALA.
